(19) United States
(12) Patent Application Publication
(10) Pub. No.: US 2019/0332322 A1
(43) Pub. Date: Oct. 31, 2019

(54) MEMORY SYSTEM INCLUDING RESISTIVE VARIABLE MEMORY DEVICE AND OPERATING METHOD THEREOF

(71) Applicant: SK hynix Inc., Icheon (KR)

(72) Inventors: Jung Hyun KWON, Seoul (KR); Seung Gyu JEONG, Gwangmyeong (KR); Won Gyu SHIN, Seoul (KR); Do-Sun HONG, Icheon (KR)

(21) Appl. No.: 16/191,318

(22) Filed: Nov. 14, 2018

(30) Foreign Application Priority Data
Apr. 25, 2018 (KR) 10-2018-0048046

(51) Int. Cl. G06F 3/06; G06F 12/1009

(52) U.S. Cl. CPC G06F 3/0659; G06F 3/0604; G06F 3/064; G06F 2212/657; G06F 12/1009; G06F 2212/1044; G06F 3/0673

(57) ABSTRACT

A memory system includes a memory device and a memory controller. The memory device includes a plurality of cell regions. The memory controller controls an operation of the memory device. The memory controller includes a random access memory (RAM) and a cell region management unit. The RAM stores an address mapping table. The address mapping table includes physical block addresses for the plurality of cell regions, logical block addresses mapped with the physical block addresses, and status values corresponding to the physical block addresses. The cell region management unit determines whether there is a first cell region to be cleared among the plurality of cell regions, based on the status values, generates a cell clear command when there is the first cell region, and transmits the cell clear command to the memory device.

### CROSS-REFERENCES TO RELATED APPLICATION

The present application claims priority under 35 U.S.C. § 119(a) to Korean Patent Application Number 10-2018-0048046, filed on Apr. 25, 2018, in the Korean Intellectual Property Office, which is incorporated herein by reference in its entirety.

### BACKGROUND

### 1. Technical Field

Various embodiments of the present disclosure generally relate to a memory system, and more particularly, to a memory system including a resistive variable memory device, and an operating method thereof.

### 2. Related Art

As memory devices with high performance and low power consumption have been demanded, research is being conducted on next-generation semiconductor memory devices that are non-volatile and that do not require refresh operations.

Next-generation memory devices generally require the high capacity of a dynamic random access memory (DRAM), the non-volatile characteristic of a flash memory, the high speed of a static RAM (SRAM), and the like. The next-generation memory devices may include a phase-change random access memory device (PRAM), a nano-floating gate memory (NFGM), a polymer RAM (PoRAM), a magnetic RAM (MRAM), a ferroelectric RAM (FeRAM), a resistive RAM (ReRAM), and the like.

### SUMMARY

Embodiments of the present disclosure relate to a memory system capable of preventing degradation of a memory cell and reducing power consumption in operations thereof, and an operating method thereof.

In an embodiment of the present disclosure, a memory system may include: a memory device including a plurality of cell regions; and a memory controller configured to control an operation of the memory device. The memory controller may include: a random access memory (RAM) that stores an address mapping table, of the address mapping table including physical block addresses for the plurality of cell regions, logical block addresses mapped with the physical block addresses, and status values corresponding to the physical block addresses; and a cell region management unit configured to determine whether there is a first cell region to be cleared among the plurality of cell regions, based on the status values, generate a cell clear command when there is the first cell region, and transmit the cell clear command to the memory device. The memory device may perform a clear operation for programming memory cells in the first cell region to a first resistance state or a second resistance state in response to the cell clear command.

In an embodiment of the present disclosure, a method for operating a memory system, the method may include: determining whether there is a first cell region to be cleared based on status values in an address mapping table, the first cell region being one of a plurality of cell regions in a memory device, the address mapping table including physical block addresses for the plurality of cell regions, logical block addresses mapped with the physical block addresses, and the status values corresponding to the physical block addresses; and performing a clear operation on the first cell region, such that memory cells in the first cell region are programmed to a first resistance state or a second resistance state.

According to embodiments, in a write operation for programming memory cells to a reset state, a memory cell having a reset state may be prevented from being programmed to the reset state again and thus the deterioration of the memory cell may be suppressed and the power consumed in a write operation of the memory cell may be reduced.

These and other features, aspects, and embodiments are described below in the section entitled “DETAILED DESCRIPTION”.

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 is a block diagram illustrating a memory system according to an embodiment of the present disclosure;

FIG. 2 is a block diagram illustrating a memory controller of FIG. 1 according to an embodiment of the present disclosure;

FIG. 3 is a block diagram illustrating a memory device of FIG. 1 according to an embodiment of the present disclosure;

FIG. 4 is a block diagram illustrating a memory cell array of FIG. 3 according to an embodiment of the present disclosure;

FIG. 5 is a circuit diagram illustrating a first memory block of FIG. 4 according to an embodiment of the present disclosure;

FIGS. 6A to 6C are circuit diagrams illustrating a memory cell of FIG. 5 according to embodiments of the present disclosure;

FIG. 7A illustrates an address mapping table according to an embodiment of the present disclosure;

FIG. 7B illustrates status values stored in the address mapping table shown in FIG. 7A according to an embodiment of the present disclosure;

FIG. 8A illustrates a memory cell array for explaining a cell region clear operation according to an embodiment of the present disclosure;

FIG. 8B illustrates an example of an address mapping table corresponding to the memory cell array of FIG. 8A;

FIGS. 9A to 9D illustrate a cell region clear operation according to an embodiment of the present disclosure;

FIGS. 10A to 10D illustrate a cell region clear operation according to an embodiment of the present disclosure;

FIG. 11 is a flowchart illustrating an operating method of a memory system according to an embodiment of the present disclosure;

FIG. 12 is a block diagram illustrating a memory card system according to an embodiment of the present disclosure;

FIG. 13 is a block diagram illustrating a memory module according to an embodiment of the present disclosure;

FIG. 14 is a block diagram illustrating a solid state disc (SSD) according to an embodiment of the present disclosure; and

FIG. 15 is a block diagram illustrating a computing system according to an embodiment of the present disclosure.

### DETAILED DESCRIPTION

Various embodiments of the present disclosure will be described in greater detail with reference to the accompanying drawings. The drawings are schematic illustrations of various embodiments. As such, embodiments include variations with respect to the configurations and shapes of the illustrations. Thus, the described embodiments should not be construed as being limited to the particular configurations and shapes illustrated herein but may include deviations in configurations and shapes which do not depart from the spirit and scope of the present invention as defined in the appended claims.

FIG. 1 is a block diagram illustrating a memory system 10 according to an embodiment.

Referring to FIG. 1, the memory system 10 may include a memory device 100 and a memory controller 200. The memory device 100 may include a memory cell array 110, a write/read circuit 120, and a control logic 130. The memory cell array 110 may include memory cells. In an embodiment, the memory device 100 may be a resistive variable memory device, and thus the memory cell array 110 may include resistive variable memory cells. In this embodiment, the memory system 10 may refer to a resistive variable memory system. However, embodiments are not limited thereto.

The memory controller 200 may control the memory device 100 to read out data stored in the memory device 100 or write data in the memory device 100, in response to a read or write request from a host, respectively. For example, the memory controller 200 may control program (or write), read, and erase operations of the memory device 100 by providing an address ADDR, a command CMD, and a control signal CTRL to the memory device 100. Data DATA including write data and read data may be transmitted between the memory controller 200 and the memory device 100.

Although not shown in FIG. 1, the memory controller 200 may include a RAM, a processor, a host interface, a memory interface, and the like. The RAM may be used as a working memory of the processor. The processor may control an overall operation of the memory controller 200. The host interface may include a protocol for performing data exchange between the host and the memory controller 200. For example, the memory controller 200 may be configured to communicate with the host using at least one of various interface protocols such as a universal serial bus (USB), a multimedia card (MMC), a peripheral component interconnection-express (PCI-E), an advanced technology attachment (ATA), a serial-ATA, a parallel-ATA, a small computer system interface (SCSI), an enhanced small device interface (ESDI), an integrated drive electronics (IDE), and so on.

The memory cell array 110 may include a plurality of memory cells (not shown) arranged in regions in which a plurality of first signal lines and a plurality of second signal lines cross each other. For example, the plurality of first signal lines may be a plurality of word lines and the plurality of second signal lines may be a plurality of bit lines. In another example, the plurality of first signal lines may be a plurality of bit lines and the plurality of second signal lines may be a plurality of word lines.

In an embodiment, each of the plurality of memory cells may be a multi-level cell (MLC) configured to store 2 or more bits of data. In another embodiment, the memory cell array 110 may include single level cells (SLC) configured to store 1-bit data and MLCs. When 1-bit data is written in a single memory cell, the memory cell may have one of two resistance states according to data written therein. When 2-bit data is written in a single memory cell, the memory cell may have one of four resistance states according to data written therein. In still another embodiment, when a memory cell in the memory cell array 110 is a triple level cell (TLC) in which 3-bit data is written, the memory cell may have one of eight resistance states according to data written therein. However, the memory cell array 110 is not limited thereto and the memory cell array 110 may include memory cells, each of which stores four or more bits of data.

The memory cell array 110 may include memory cells arranged in a two-dimensional (2D) horizontal structure or memory cells arranged in a 3D vertical structure.

According to an embodiment, the memory cell array 110 may include a plurality of cell regions. Each of the cell regions may be defined in various manners. For example, a cell region may be a page unit including a plurality of memory cells coupled to the same word line. In another example, a cell region may be a unit in which a plurality of memory cells are coupled to word lines and bit lines, the word lines being coupled to one row decoder, the bit lines being coupled to one column decoder. Such a cell region may be defined as a tile (or block). Hereinafter, an example having a cell region that is a block will be described.

The memory cell array 110 may include a plurality of resistive variable memory cells. A resistive variable memory cell may include a variable resistance element (not shown) having a variable resistance. For example, the resistive variable memory device 100 may be a PRAM when the variable resistance element includes a phase-change material of which a resistance is changed according to temperature. The phase-change material may include a compound in which two or more elements are combined. For example, the compound may be a compound in which two elements are combined, such as any of GaSb, InSb, InSe, Sb₂Te₃, and GeTe; a compound in which three elements are combined, such as any of GeSbTe, GaSeTe, InSbTe, SnSb₂Te₄, and InSbGe; a compound in which four elements are combined, such as any of AgInSbTe, (GeSn)SbTe, GeSb(SeTe), and Te₈₁Ge₁₅Sb₂S₂; or the like.

The phase-change material may have an amorphous state having a relatively high resistance and a crystalline state having a relatively low resistance. A phase of the phase-change material may be changed according to Joule heating, which is generated by passing a current through the phase-change material, and a time that the phase-change material is cooled. The temperature of the phase-change material may be based on an amount of current flowing through the phase-change material.

The resistive variable memory device 100 may be an ReRAM when the variable resistance element includes an upper electrode, a lower electrode, and a complex metal oxide layer formed between the upper and lower electrodes. The resistive variable memory device 100 may be an MRAM when the variable resistance element includes a magnetic upper electrode, a magnetic lower electrode, and a dielectric layer formed between the upper and lower electrodes. Hereinafter, the memory cell array 110 will be described under the assumption that the plurality of resistive variable memory cells are PRAM cells.

The write/read circuit 120 may perform write and read operations on each memory cell of the memory cell array 110. The write/read circuit 120 may be coupled to the memory cells in the memory cell array 110 through a plurality of bit lines, and may include a write driver configured to write data in the memory cells and a sense amplifier configured to amplify data read out from the memory cells. The write/read circuit 120 may perform the write and read operations on a memory cell, which is selected by a row decoder (not shown) and a column decoder (not shown), by providing a current pulse or a voltage pulse to the selected memory cell.

The control logic 130 may control an overall operation of the memory device 100. The control logic 130 may control the write/read circuit 120 to perform a memory operation such as the write or read operation. The memory device 100 may further include a power generation circuit (not shown) configured to generate various voltages and currents used in the write and read operations and levels of the voltages and currents may be controlled by the control logic 130.

In the write operation of the memory device 100, a resistance level of a variable resistance element in a selected memory cell of the memory cell array 110 may be increased or reduced according to write data to be written therein. For example, each of the memory cells in the memory cell array 110 may have a resistance level corresponding to data currently stored therein, and the resistance level of the memory cell may be increased or reduced according to write data to be written therein. The write operation may include a reset write operation and a set write operation. In the set write operation, data corresponding to a set state is written in a resistive variable memory cell, and the set state may have a relatively low resistance level that corresponds to a low resistance state. In the reset write operation, data corresponding to a reset state is written in a resistive variable memory cell, and the reset state may have a relatively high resistance level that corresponds to a high resistance state.

The memory controller 200 and the memory device 100 may be integrated in a single semiconductor device. For example, the memory controller 200 and the memory device 100 may be integrated in a single semiconductor device to implement a memory card. For example, the memory controller 200 and the memory device 100 may be integrated in a single semiconductor device to implement a personal computer (PC) card (PCMCIA), a compact flash card (CFC), a smart media card (SM/SMC), a memory stick, a multimedia card (MMC, RS-MMC, micro-MMC), a secure digital card (SD, mini-SD, micro-SD), a universal flash storage device (UFS), or the like. In another example, the memory controller 200 and the memory device 100 may be integrated in a single semiconductor device to implement a solid state disc/drive (SSD).

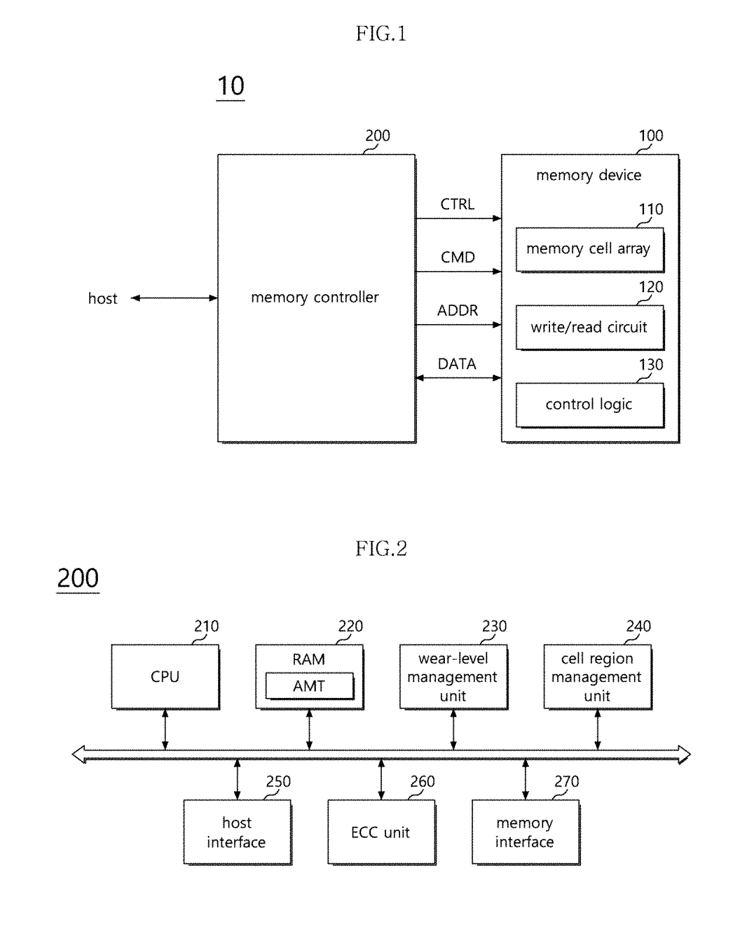

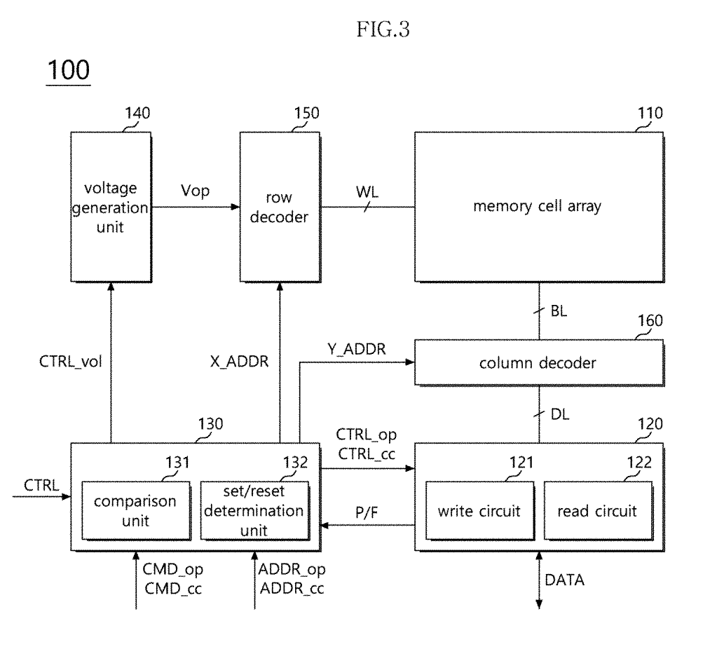

FIG. 2 is a block diagram illustrating the memory controller 200 of FIG. 1 according to an embodiment.

Referring to FIG. 2, the memory controller 200 may include a central processing unit (CPU) 210, a RAM 220, a wear-level management unit 230, a cell region management unit 240, a host interface 250, an error correction code (ECC) unit 260, and a memory interface 270. The memory controller 200 may further include various components other than the components shown in FIG. 2. For example, although they are not shown in FIG. 2, the memory controller 200 may further include a read only memory (ROM) configured to store code data required for initial booting of a device employing the memory system 10, a buffer memory controller configured to control a buffer memory, and the like.

The CPU 210 may control an overall operation of the memory controller 200. For example, the CPU 210 may control various functional blocks related to a memory operation of a memory device, e.g., the memory device 100 shown in FIG. 1. The CPU 210 may drive firmware for controlling the memory controller 200.

The RAM 220 may be a DRAM or an SRAM. The RAM 220 may temporarily store data which is to be written in the memory device 100 or data read out from the memory device 100. For example, the RAM 220 may operate as a buffer memory of the memory controller 200. The RAM 220 may store firmware driven by the CPU 210. The RAM 220 may store data required for driving the firmware, for example, meta data. For example, the RAM 220 may operate as a working memory of the CPU 210. Although FIG. 2 illustrates the RAM 220 that is included in the memory controller 200, the RAM 220 may be provided in the outside of the memory controller 200 according to another embodiment.

The RAM 220 may store an address mapping table AMT. The address mapping table AMT may include mapping information between a logical block address LBA received from a host and a physical block address PBA of the memory device 100 corresponding to the logical block address LBA. The address mapping table AMT may further include status information for a memory region designated by the physical block address PBA. The address mapping table AMT will be described below in detail with reference to the drawings.

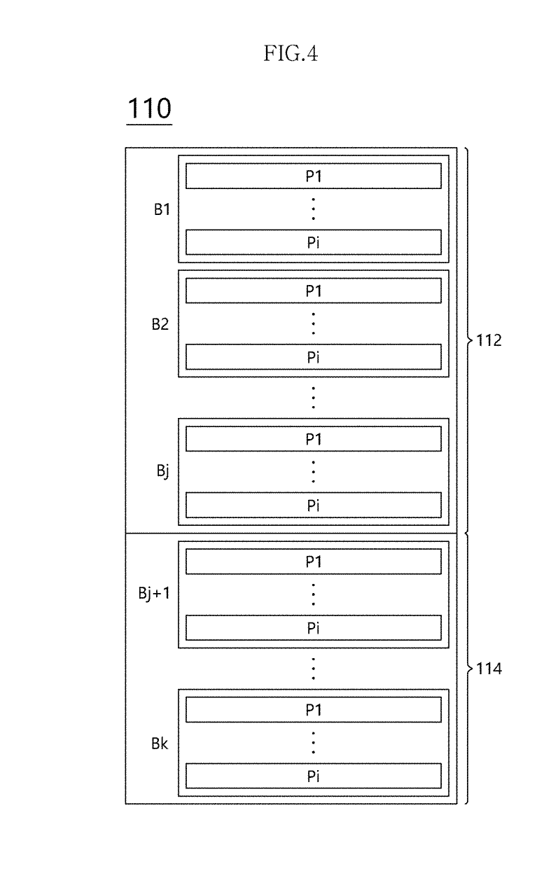

The wear-level management unit 230 may be configured to manage a wear level for each of a plurality of memory blocks (e.g., B1 to Bk shown in FIG. 4) included in the memory cell array 110. For example, the wear-level management unit 230 may level out the wear levels for the memory blocks B1 to Bk by determining a write count (or a program count) for each of the memory blocks B1 to Bk and moving data, which are stored in a first memory block having a write count that is equal to or larger than a preset threshold count, to a second memory block having a write count that is smaller than the preset threshold count. A write count represents how many times a write operation (or a program operation) has been performed on a memory block. The wear-level management unit 230 may operate under the control of the CPU 210.

When data that have been stored in the first memory block are moved to the second memory block, the data stored in the first memory block may be invalid, and the data moved to and stored in the second memory block may be valid data. The invalid data stored in the first memory block are useless data. In an embodiment, a memory block in which invalid data are stored may be referred to as a ‘clear target block.’

When data are moved from the first memory block to the second memory block and stored in the second memory block, a logical block address LBA, which has been mapped with a physical block address PBA of the first memory block, may be re-mapped with a physical block address PBA of the second memory block. Accordingly, although the access to the same logical block address LBA is requested from the host, the memory controller 200 may access not the physical block address PBA of the previously mapped first memory block but the physical block address PBA of the re-mapped second memory block.

The cell region management unit 240 may check statuses of cell regions, for example, the memory blocks B1 to Bk of the memory cell array 110, and determine whether or not to perform a cell region clear operation on the memory blocks B1 to Bk according to the statuses of the memory blocks B1 to Bk. In an embodiment, the cell region clear operation may allow all memory cells in a memory block to have a value corresponding to the same resistance state. Accordingly, in an embodiment, all memory cells in a cleared memory block (for example, a free block) on which the cell region clear operation has been performed may have a first resistance state or a second resistance state. In an embodiment, the first resistance state is one of the set state and the reset state, and the second resistance state is the other one of the set state and the reset state.

The cell region management unit 240 may check status values for physical block addresses PBAs stored in a status value field of the address mapping table AMT and determine whether there is a target memory block to be cleared among the plurality of memory blocks B1 to Bk based on the status values. When there is the target memory block, the cell region management unit 240 may generate a cell clear command CMD_cc for performing a cell region clear operation on the target memory block and provide the cell clear command CMD_cc to the memory device 100 through the memory interface 270. The cell region management unit 240 may operate under the control of the CPU 210.

The host interface 250 may provide an interface between the host and the memory controller 200 and receive a request for a memory operation from the host. For example, the host interface 250 may receive various requests such as a data write request, a data read request, and the like from the host, and the memory controller 200 may generate various internal signals corresponding to memory operations to be performed in the memory device 100 in response to the received requests. For example, the memory controller 200 may communicate with the host through various standard interfaces, and the standard interfaces may include an advanced technology attachment (ATA) interface, a serial ATA (SATA) interface, an external SATA (e-SATA) interface, a parallel ATA (PATA) interface, a small computer system interface (SCSI), a serial attached SCSI (SAS) interface, a peripheral component interconnect (PCI) interface, a peripheral component interconnect-express (PCI-E) interface, an IEEE 1934 interface, a universal serial bus (USB) interface, an integrated device electronics (IDE) interface, a secure digital (SD) card interface, a multimedia card (MMC) interface, an embedded MMC (eMMC) interface, a compact flash (CF) card interface, and so on.

The ECC unit 260 may perform ECC encoding on write data and ECC decoding on read data. The ECC unit 260 may generate an error detection result for the data read out from the memory device 100 and perform an ECC operation on the read-out data. The ECC unit 260 may perform the ECC encoding and the ECC decoding in preset units. The ECC unit 260 may perform the ECC encoding and the ECC decoding using algorithms such as a Reed-Solomon (RS) code, a Hamming code, a cyclic redundancy code (CRC), and the like. The ECC encoding may include an operation of generating parity bits for data to be written in the memory device 100 and the ECC decoding may include an operation of detecting an error bit from data read out from the memory device 100 using the parity bits and correcting the detected error bit.

The ECC unit 260 may be set to have preset error correction capacity. As the error correction capacity is increased, the number of parity bits generated per data having the same size may be increased. For example, as the error correction capacity is increased, the ECC unit 260 can correct more error bits per preset number of data or per ECC unit. Although FIG. 2 illustrates the ECC unit 260 that is an internal component of the memory controller 200, the function of the ECC unit 260 may be implemented in the memory device 100.

The memory interface 270 may provide an interface between the memory controller 200 and the memory device 100. The memory controller 200 may provide a command corresponding to a request from the host, commands corresponding to background operations, and the like to the memory device 100 through the memory interface 270. Write data and read data may be transmitted between the memory controller 200 and the memory device 100 through the memory interface 270.

FIG. 3 is a block diagram illustrating the memory device 100 of FIG. 1 according to an embodiment.

Referring to FIG. 3, the memory device 100 may include the memory cell array 110, the write/read circuit 120, the control logic 130, and a voltage generation unit 140. The memory device 100 may further include a row decoder 150 and a column decoder 160. The write/read circuit 120 may include a write circuit 121 and a read circuit 122.

The memory cell array 110 may be coupled to a plurality of first signal lines and a plurality of second signal lines. The memory cell array 110 may include a plurality of memory cells arranged in regions in which the plurality of first signal lines and the plurality of second signal lines cross each other. In an embodiment, the plurality of first signal lines are word lines WL, and the plurality of second lines are bit lines BL.

The memory device 100 may receive an address ADDR for accessing a selected memory cell and a command CMD, and the address ADDR may include a row address X_ADDR for selecting word lines WL and a column address Y_ADDR for selecting bit lines BL. The row decoder 150 may be coupled to the memory cell array 110 through the word lines WL and select at least one of the word lines WL based on the row address X_ADDR. The column decoder 160 may be coupled to the memory cell array 110 through the bit lines BL and select at least one of the bit lines BL based on the column address Y_ADDR.

The write/read circuit 120 may write data DATA received from the outside in the memory cell array 110 or may sense data read out of the memory cell array 110 and output the sensed data to the outside, under the control of the control logic 130. The write/read circuit 120 may provide a write result or a read result to the control logic 130. For example, the write/read circuit 120 may perform a verify operation for verifying a result of a write operation and provide a verify result signal (for example, a pass or fail (P/F) signal) to the control logic 130 in the write operation.

The write/read circuit 120 may be selectively coupled to the row decoder 150 or the column decoder 160. Accordingly, the write/read circuit 120 may be selectively coupled to the word lines WL or the bit lines BL to write data in a selected memory cell or to read out data from the selected memory cell.

The write/read circuit 120 may include the write circuit 121 and the read circuit 122. The write circuit 121 may be coupled to a bit line BL selected by the column decoder 160 and perform a program operation (or a write operation) by providing a program pulse to the selected memory cell. Accordingly, the write circuit 121 may input write data DATA to the memory cell array 110. The program pulse may refer to a write pulse. The program pulse may be a current pulse or a voltage pulse.

For example, the write circuit 121 may perform a set write operation to program a selected memory cell MC in such a manner that a resistance level of the selected memory cell MC is reduced. The write circuit 121 may also perform a reset write operation to program the selected memory cell MC in such a manner that the resistance level of the selected memory cell MC is increased.

The read circuit 122 may be coupled to the bit line BL selected by the column decoder 160 to read out data DATA stored in the selected memory cell MC by determining a resistance level of the selected memory cell MC. The read circuit 122 may sense a voltage of the selected bit line BL to which the selected memory cell MC is coupled and comparing the sensed voltage with a reference voltage. When the selected memory cell MC is an MLC, the read circuit 122 may determine the resistance level of the selected memory cell MC by comparing the sensed voltage of the selected bit line BL with a plurality of reference voltages.

When a normal read command CMD_op is received from the memory controller 200, the read circuit 122 may perform a normal read operation for corresponding memory cells MC. When the cell clear command CMD_cc is received from the memory controller 200, the read circuit 122 may perform a pre-read operation which reads resistance states of the corresponding memory cells MC. The read circuit 122 may also perform a verify operation for determining whether or not a write operation for the memory cell MC is correctly performed after the write operation is performed.

The read circuit 122 may provide the read data DATA to the outside of the memory device 100, for example, to the memory controller 200, in the normal read operation. In the pre-read operation, the read circuit 122 may provide the read data DATA to the control logic 130.

Although FIG. 3 illustrates the write circuit 121 and the read circuit 122 that are coupled to the bit line BL, embodiments are not limited thereto. In another embodiment, the write circuit 121 and the read circuit 122 may be coupled to the word line WL. In further another embodiment, the write circuit 121 may be coupled to the word line WL, and the read circuit 122 may be coupled to the bit line BL. In still another embodiment, the write circuit 121 may be coupled to the bit line BL, and the read circuit 122 may be coupled to the word line WL.

The voltage generation unit 140 may generate various voltages for performing write, read, and erase operations on the memory cell array 110, based on a voltage control signal CTRL_vol provided by the control logic 130. The voltage generation unit 140 may generate driving voltages Vop for driving the plurality of word lines WL and the plurality of bit lines BL. The voltage generation unit 140 may generate one or more reference voltages for reading data stored in a memory cell MC. The voltage generation unit 140 may generate a plurality of reference voltages to read out data from an MLC, and may sequentially provide the plurality of reference voltages to the read circuit 122.

The control logic 130 may output various control signals for writing data DATA in the memory cell array 110, reading out data DATA from the memory cell array 110, and clearing a specific cell region of the memory cell array 110, based on the commands CMD_op and CMD_cc, addresses ADDR_op and ADDR_cc, and the control signal CTRL received from the memory controller 200. The specific cell region to be cleared may be the whole or a portion of a memory block. The various control signals output from the control logic 130 may be provided to the write/read circuit 120, the voltage generation unit 140, the row decoder 150, and the column decoder 160. Accordingly, the control logic 130 may control an overall operation of the memory device 100.

For example, the control logic 130 may generate normal operation control signals CTRL_op based on the normal read command CMD_op and the control signal CTRL and provide the generated normal operation control signals CTRL_op to the write/read circuit 120. The control logic 130 may provide the row address X_ADDR to the row decoder 150 and the column address Y_ADDR to the column decoder 160 based on the addresses ADDR_op and ADDR_cc. The control logic 130 may generate clear operation control signals CTRL_cc based on the cell clear command CMD_cc and the control signal CTRL and provide the generated clear operation control signals CTRL_cc to the write/read circuit 120.

FIG. 4 is a block diagram illustrating the memory cell array 110 of FIG. 3 according to an embodiment.

Referring to FIG. 4, the memory cell array 110 may include the plurality of memory blocks B1 to Bk. Each of the memory blocks B1 to Bk may include a plurality of pages P1 to Pi, and each of the pages P1 to Pi may include a plurality of memory cells that are coupled to the same word line. The memory cell array 110 may include a first region 112 which can be recognized by the host and a second region 114 which cannot be recognized by the host. The first region 112 may be referred to as a ‘user region.’ The second region 114 may be referred to as a ‘spare area.’

For example, in the memory cell array 110, the first region 112 may include j memory blocks B1 to Bj, and the second region 114 may include (k-j) memory blocks Bj+1 to Bk. Here, i, j, and k may be natural numbers and k may be larger than j. The host may transmit logical block addresses LBA to the memory system 10, the logical block addresses LBA corresponding to physical block addresses PBA for accessing the first region 112 in the memory cell array 110.

FIG. 5 is a circuit diagram illustrating the memory cell array 110 of FIG. 4 according to an embodiment.

Referring to FIG. 5, the memory cell array 110 may have a 2D memory structure and include a plurality of word lines WL1 to WLn, a plurality of bit lines BL1 to BLm, and a plurality of memory cells MC arranged in intersection regions of the word lines WL1 to WLn and the bit lines BL1 to BLm, m and n being positive integers. Memory cells MC coupled to the same word line may refer to a page unit. The number of word lines WL, the number of bit lines BL, and the number of memory cells MC may be variously changed according to embodiments. Although FIG. 5 illustrates the memory cell array 110 having the 2D memory structure, embodiments are not limited thereto. In another embodiment, the memory cell array 110 may have a 3D memory structure.

According to an embodiment, each of the plurality of memory cells MC may include a variable resistance element R and a selection element S. The variable resistance element R may include a variable resistance material, and the selection element S may be referred to as a ‘switching element.’

For example, the selection element S may be coupled between one of the plurality of word lines WL1 to WLn and the variable resistance element R, and the variable resistance element R may be coupled between the selection element S and one of the plurality of bit lines BL1 to BLm. However, embodiments are not limited thereto. In another embodiment, the variable resistance element R may be coupled between one of the plurality of word lines WL1 to WLn and the selection element S, and the selection element S may be coupled to the variable resistance element R and one of the plurality of bit lines BL1 to BLm.

The variable resistance element R may be changed to one state among a plurality of resistance states according to an applied electrical pulse. The variable resistance element R may include a phase-change material layer, which has a resistance state changing according to an amount of current applied thereto. The phase-change material layer may include a compound in which two or more elements are combined. For example, the compound may be a compound in which two elements are combined, such as any of GaSb, InSb, InSe, Sb₂Te₃, and GeTe; a compound in which three elements are combined, such as any of GeSbTe, GaSeTe, InSbTe, SnSb₂Te₄, and InSbGe; a compound in which four elements are combined, such as any of AgInSbTe, (GeSn)SbTe, GeSb(SeTe), Te₈₁Ge₁₅Sb₂S₂; or the like. The phase-change material layer may have an amorphous state having a relatively high resistance and a crystalline state having a relatively low resistance. A phase of the phase-change material layer may be changed according to Joule heating, which is generated by passing a current through the phase-change material layer, and a time that the phase-change material layer is cooled. The temperature of the phase-change material layer may be based on an amount of current flowing through the phase-change material layer. Data may be written in the memory cell array 110 using the phase-change of the phase-change material layer.

The selection element S may be coupled between any one of the plurality of word lines WL1 to WLn and the variable resistance element R and control a current supplied to the variable resistance element R according to voltages applied to the coupled word line and bit line. The selection element S may be a diode having a PN junction or a PIN junction. An anode of the diode may be coupled to the variable resistance element R and a cathode of the diode may be coupled to one of the plurality of word lines WL1 to WLn. When a voltage difference between the anode and cathode of the diode is larger than a threshold voltage of the diode, the diode may be turned on and the current may be applied to the variable resistance element R. Although FIG. 5 illustrates the selection element S that is the diode, but embodiments are not limited thereto. In other embodiments, the selection element S may be any switchable element.

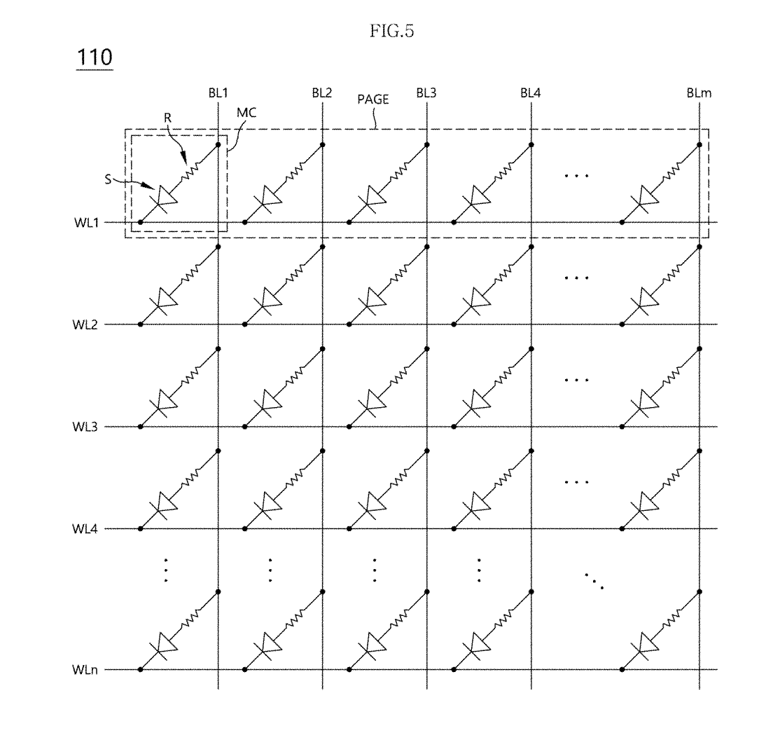

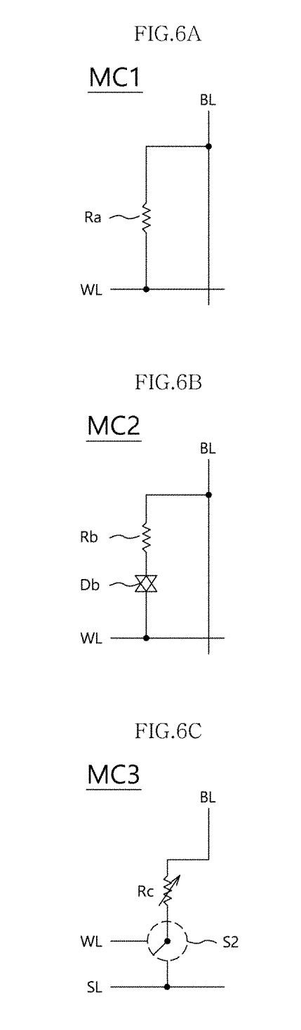

FIGS. 6A to 6C are circuit diagrams illustrating the memory cell MC of FIG. 5 according to embodiments.

Referring to FIG. 6A, a memory cell MC1 may include a variable resistance element Ra, and the variable resistor element Ra may be coupled between a bit line BL and a word line WL. The memory cell MC1 may store data according to voltages applied to the bit line BL and the word line WL.

Referring to FIG. 6B, a memory cell MC2 may include a variable resistance element Rb and a bidirectional diode Db. The variable resistance element Rb may include a resistive material for storing data. The bidirectional diode Db may be coupled between the variable resistance element Rb and a word line WL, and the variable resistance element Rb may be coupled between a bit line BL and the bidirectional diode Db. The positions of the bidirectional diode Db and the variable resistance element Rb may be exchanged between the word line WL and the bit line BL. A leakage current flowing through a non-selected variable resistance element Rb may be blocked by a bidirectional diode Db coupled to the non-selected variable resistance element Rb.

Referring to FIG. 6C, a memory cell MC3 may include a variable resistance element Rc and a three-state switch S2. The is variable resistance element Rc may be coupled between a bit line BL and the three-state switch S2, and the three-state switch S2 may be coupled between the variable resistance element Rc and a source line SL. The three-state switch S2 may be configured to supply and block a current to the variable resistance element Rc according to a voltage of a word line WL. The three-state switch S2 may be a transistor or an ovonic threshold switch. When the three-state switch S2 is used, the source line SL may be further included to control voltage levels of both terminals of the variable resistance element Rc. The positions of the three-state switch S2 and the variable resistor element Rc may be exchanged between the bit line BL and the source line SL.

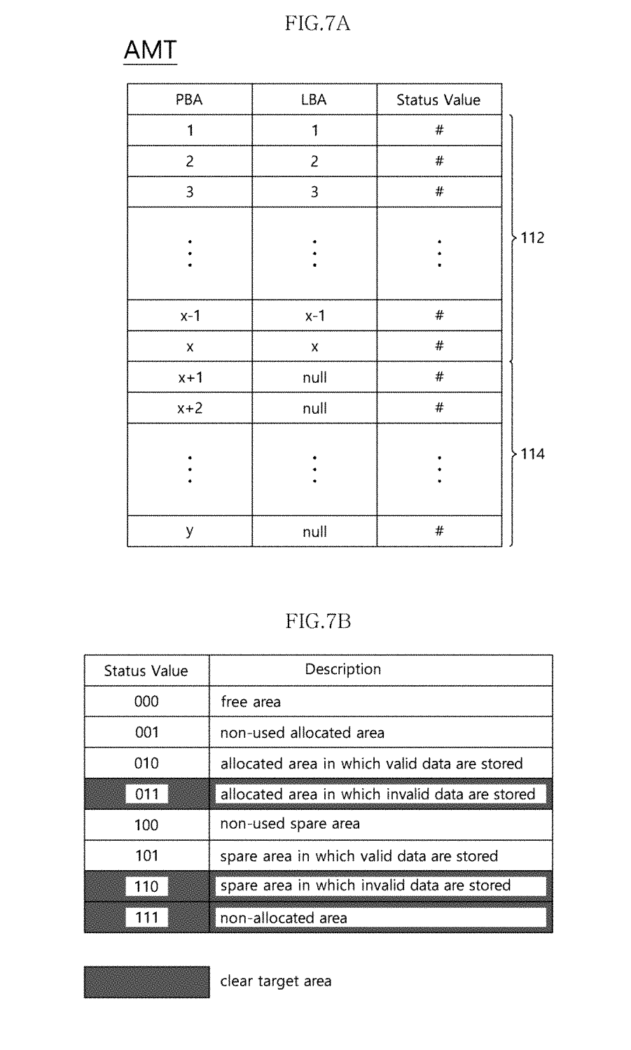

FIG. 7A illustrates an address mapping table AMT according to an embodiment, and FIG. 7B illustrates status values stored in state value fields of the address mapping table AMT shown in FIG. 7A.

Referring to FIG. 7A, the address mapping table AMT may be configured to store y physical block addresses PBA, x logical block addresses LBA that are mapped with x physical block addresses PBA, and status values corresponding to the physical block addresses PBA. Here, y and x may be natural numbers, and y may be larger than x. The status values stored in the status value fields of the address mapping table AMT and the definition of the status values are illustrated in FIG. 7B.

FIG. 7B illustrates the status values, each of which is represented with 3 bits, but embodiments are not limited thereto. FIG. 7B illustrates 8 status values, but the number of status values is not limited thereto and may be changed according to the design and needs. In this embodiment shown in FIG. 7B, the 8 status values represent 8 statuses that are distinguished from each other by 3 bits, each of the 8 status values being a 3-bit value.

Referring to FIGS. 7A and 7B, a status value corresponding to one status among the 8 statuses may be stored in a status value field for each physical block address PBA in the address mapping table AMT. The 8 statuses may include a status indicating a free area, a status indicating a non-used allocated area, a status indicating an allocated area in which valid data are stored, a status indicating an allocated area in which invalid data are stored, a status indicating a non-used spare area, a status indicating a spare area in which valid data are stored, a status indicating a spare area in which invalid data are stored, and a status indicating a non-allocated area.

The free area may refer to a cleared cell region. The allocated area may refer to a cell region in the first region 112 of the memory cell array 110, which is used by the host. The non-allocated area may refer to a cell region in the first region 112 of the memory cell array 110, which is not used by the host. The spare area may refer to a cell region that cannot be recognized by the host, for example, the second region 114 of the memory cell array 110.

The non-used allocated area may refer to a cell region on which a write operation requested by the host has not been performed yet. Thus, there is no data stored in the non-used allocated area. The allocated area in which valid data are stored may refer to a cell region on which a write operation requested by the host has been performed. The allocated area in which invalid data are stored may refer to a cell region in which data stored therein have been moved to another cell region, e.g., the allocated area or the spare area.

The non-used spare area may refer to a cell region in which no data is stored. The spare area in which valid data are stored may refer to a cell region that stores data moved from another cell region (for example, a cell region in the allocated area). For example, when a write count of a specific cell region, in which valid data are stored, in the allocated area is equal to or larger than a preset threshold count, the memory controller 200 may control the memory device 100 to move the data stored in the specific cell region to the spare area. The spare area in which invalid data are stored may refer to a cell region from which data stored therein have been moved to another cell region.

In an embodiment, the allocated area in which invalid data are stored, the spare area in which invalid data are stored, and the non-allocated area may correspond to a cell region to be cleared, i.e., a clear target cell region. For example, in the memory cell array 110, cell regions in which useless data are stored and cell regions which are not used by the host may correspond to the clear target cell region. The memory controller 200 may determine whether there is a clear target cell region corresponding to the allocated area in which invalid data are stored, the spare area in which invalid data are stored, or the non-allocated area with reference to the status values stored in the status value fields of the address mapping table AMT, and may control the memory device 100 to perform a cell region clear operation on the clear target cell region.

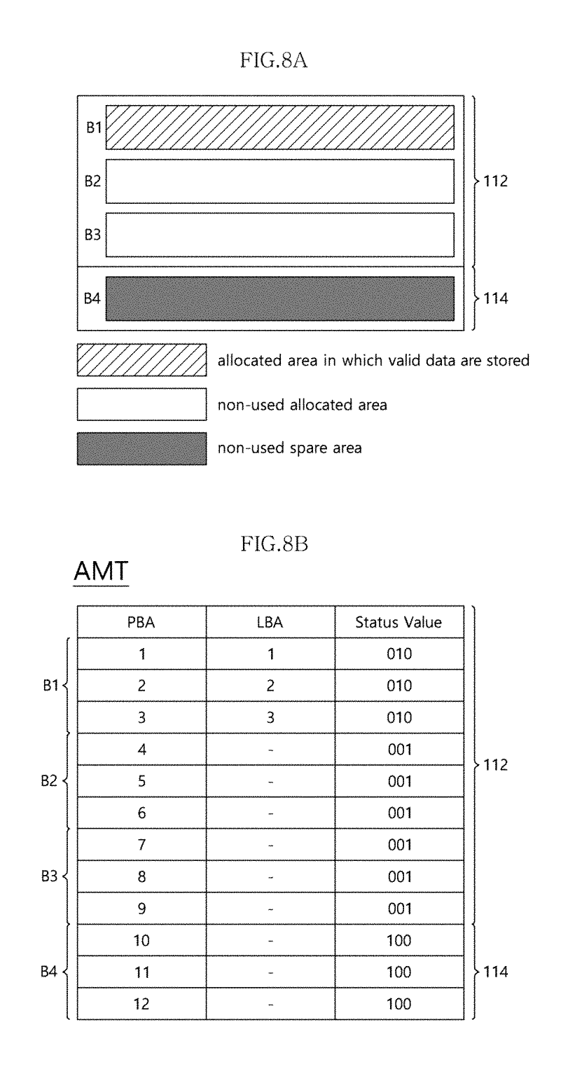

FIG. 8A illustrates an example of the memory cell array 110 for explaining a cell region clear operation according to an embodiment, and FIG. 8B illustrates an address mapping table AMT corresponding to the memory cell array 110 of FIG. 8A. For simplification of explanation, it is assumed that the memory cell array 110 includes four memory blocks B1 to B4 and each of the memory blocks B1 to B4 includes three pages. It is further assumed that the first region 112 (for example, the user region) of the memory cell array 110 includes the three memory blocks B1 to B3 and the second region 114 (for example, the spare area) includes one memory block B4.

Referring to FIG. 8A, the first memory block B1 of the memory cell array 110 may be the allocated area in which valid data are stored, and may store write data corresponding to a write request of the host. The remaining second and third memory blocks B2 and B3 may be the non-used allocated area. Accordingly, as illustrated in FIG. 8B, physical block addresses 1 to 3 corresponding to three pages of the first memory block B1 may be mapped with logical block addresses 1 to 3 in the address mapping table AMT. A status value ‘010’ corresponding to the allocated area in which valid data are stored, a status value ‘001’ corresponding to the non-used allocated area, and a status value ‘100’ corresponding to the non-used spare area may be stored in status value fields for the physical block addresses 1 to 3, the physical block addresses 4 to 9, and the physical block addresses 10 to 12, respectively.

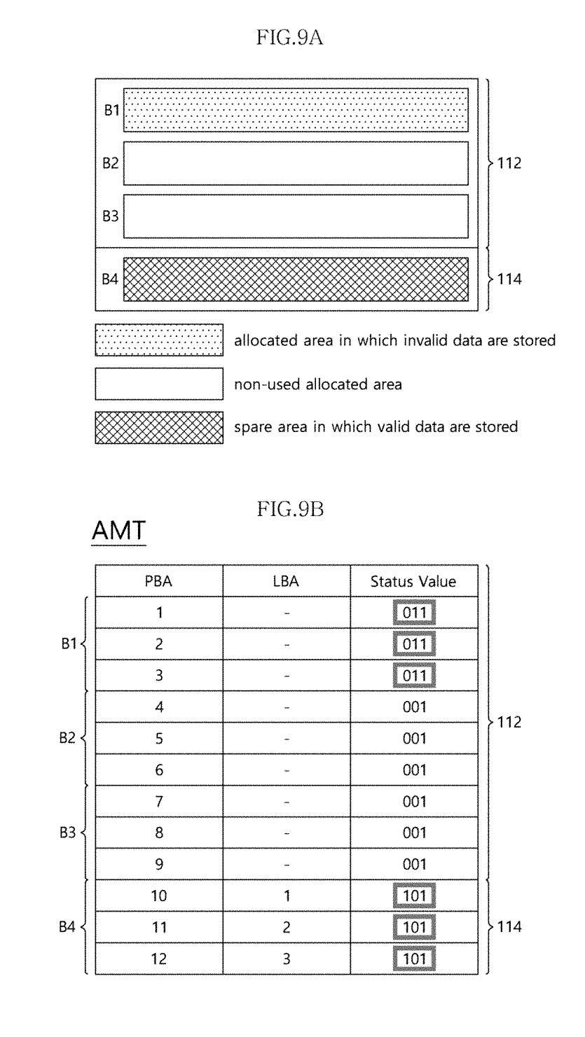

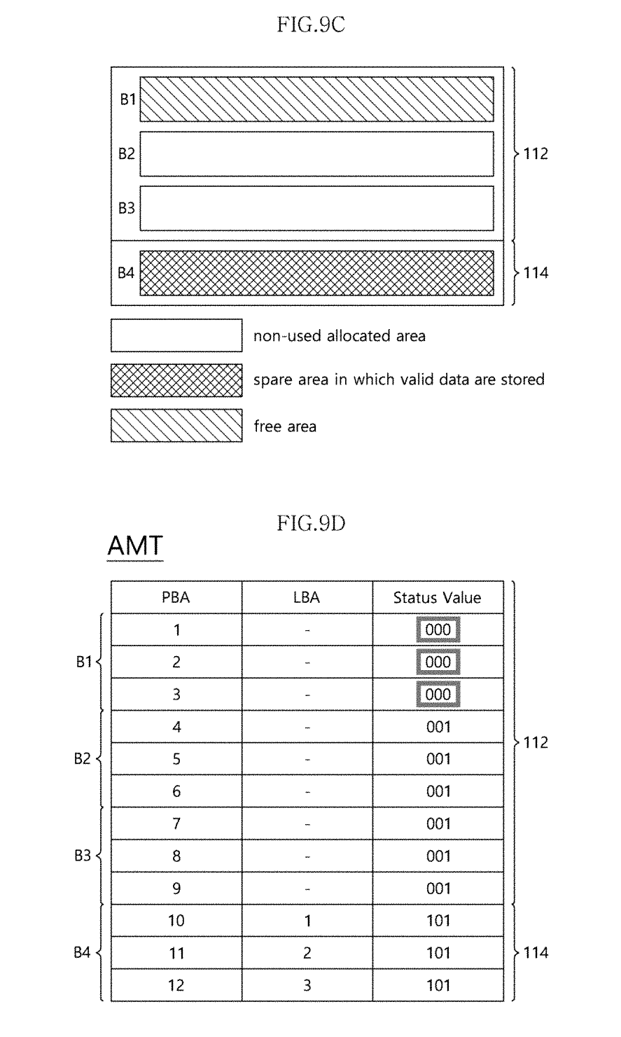

When a write count of the first memory block B1 is equal to or larger than a preset threshold count, a wear-level management unit (e.g., the wear-level management unit 230 of FIG. 2) of a memory controller (e.g., the memory controller 200 of FIG. 2) may move data stored in the first memory block B1 to another memory block, for example, a memory block having a relatively low write count that is smaller than the preset threshold count. In an embodiment, the data stored in the first memory block B1 are moved to the fourth memory block B4 in the second region 114. The data movement will be described with reference to FIGS. 9A and 9B.

Referring to FIG. 9A, as the data stored in the first memory block B1 are moved to the fourth memory block B4, the data stored in the first memory block B1 may be invalid, and the data moved to and stored in the fourth memory block B4 may be valid data. Accordingly, as illustrated in FIG. 9B, the logical block addresses 1 to 3 corresponding to the physical block addresses 1 to 3 of the first memory block B1 may be re-mapped with the physical block addresses 10 to 12 of the fourth memory block B4 in the address mapping table AMT. The status value ‘011’ indicating the allocated area in which invalid data are stored may be stored in the status value fields for the physical block addresses 1 to 3 of the first memory block B1, and the status value ‘101’ indicating the spare area in which valid data are stored may be stored in the status value fields for the physical block addresses 10 to 12 of the fourth memory block B4.

A cell region management unit (e.g., the cell region management unit 240 of FIG. 2) may determine whether there is a cell region to be cleared with reference to the status value fields of the address mapping table AMT. As illustrated in FIG. 9B, since the status values for the physical block addresses 1 to 3 of the first memory block B1 are changed to the status value ‘011,’ after the data stored in the first memory block B1 have been moved to the fourth memory block B4, the cell region management unit 240 may determine that the cell region corresponding to the physical block addresses 1 to 3 of the first memory block B1 is a cell region to be cleared, and may provide the memory device 100 with the cell clear command CMD_cc for performing the cell region clear operation on the first memory block B1 and the address ADDR_cc corresponding to the physical block addresses 1 to 3 of the first memory block B1, through a memory interface (e.g., the memory interface 270 of FIG. 2).

A control logic (e.g., the control logic 130 of FIG. 3) of the memory device 100 may read out data that are stored in the first memory block B1 based on the cell clear command CMD_cc and the address ADDR_cc received from the memory controller 200, compare each bit of the read-out data and a reference voltage using a comparison unit 131, and determine whether or not each bit of the read-out data has a set state or a reset state using a set/reset determination unit 132. For example, the set/reset determination unit 132 may determine whether each bit of the read-out data has the set state or the reset state. In an embodiment, the comparison unit 131 and the set/reset determination unit 132 are included in the control logic 130, as illustrated in FIG. 3.

The control logic 130 may control the write/read circuit 120 to perform a write operation for programming all memory cells in the cell region corresponding to the physical block addresses 1 to 3 of the first memory block B1 to the set state or the reset state. For example, when the set state and the reset state are mixed in the read-out data and when the cell region clear operation is performed to allow the memory cells in the cell region to have the set state, the control logic 130 may control the write/read circuit 120 to perform the write operation for programming only memory cells having the reset state, among the memory cells in the cell region corresponding to the physical block addresses 1 to 3 of the first memory block B1, to the set state. In another example, when the cell region clear operation is performed to allow the memory cells in the cell region to have the reset state, the control logic 130 may control the write/read circuit 120 to perform the write operation for programming only memory cells having the set state, among the memory cells in the cell region corresponding to the physical block addresses 1 to 3 of the first memory block B1, to the reset state.

Accordingly, after the cell region clear operation is performed on the cell region corresponding to the physical block addresses 1 to 3 of the first memory block B1, all the memory cells in the cell region corresponding to the physical block addresses 1 to 3 of the first memory block B1 may have the set state or the reset state. The memory cell array 110 in which the first memory block B1 is cleared is illustrated in FIG. 9C. As illustrated in FIG. 9D, after the first memory block B1 is cleared, a status value ‘000’ indicating the free area may be stored in the status value fields for the physical block addresses 1 to 3 corresponding to the first memory block B1 in the address mapping table AMT.

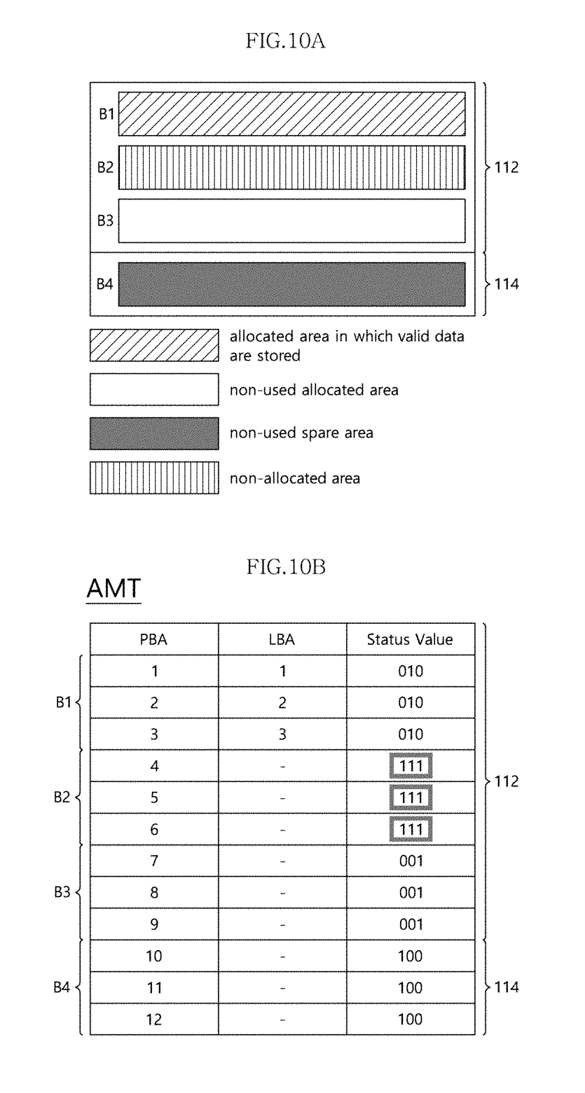

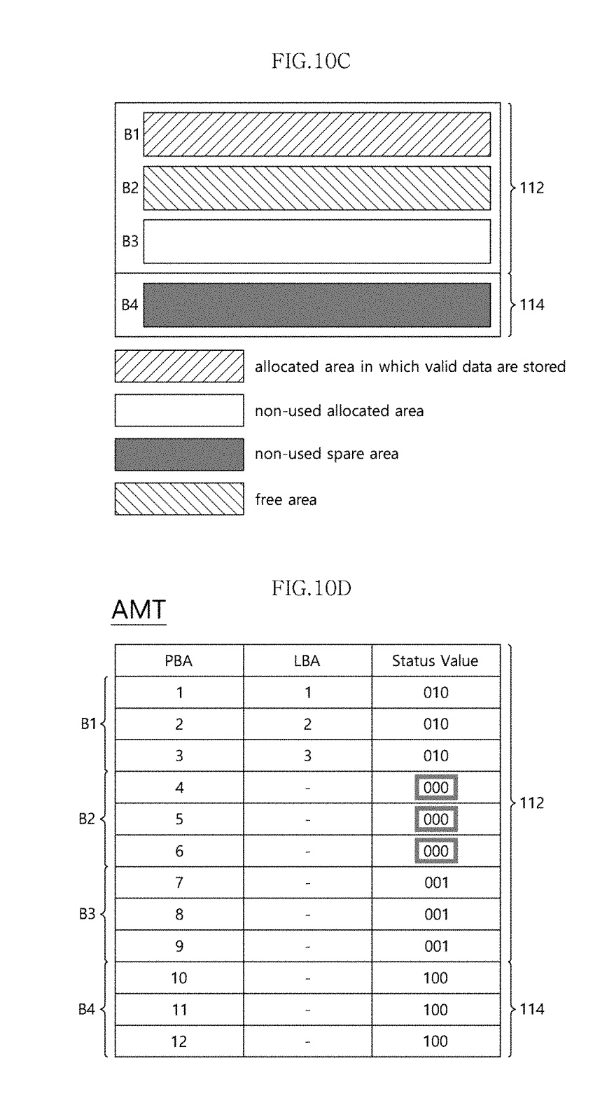

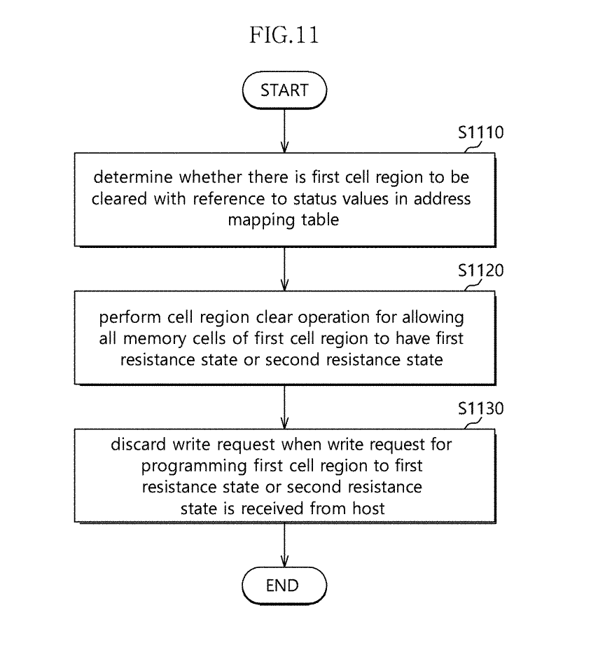

As described above, the first region 112 may include a non-allocated area that is not used by the host. The memory controller 200 may recognize that the first region 112 includes the non-allocated area by receiving information indicating that a specific cell region in the first region 112 is not used by the host. For example, information indicating that the second memory block B2 of the first region 112 is not used may be received from the host, which will be described with reference to FIGS. 10A and 10B.

As illustrated in FIGS. 10A and 10B, when the first memory block B1 is the allocated area in which valid data are stored and the second memory block B2 is the non-allocated area that is not used by the host, the status value ‘111’ indicating the non-allocated area may be stored in the status value fields for the physical block addresses 4 to 6 of the second memory block B2 in the address mapping table AMT.

Accordingly, the cell region management unit 240 may determine the cell region corresponding to the physical block addresses 4 to 6 of the second memory block B2 as a clear target cell region that is to be cleared, and may provide the cell clear command CMD_cc for performing the cell region clear operation on the second memory block B2 and the address ADDR_cc corresponding to the physical block addresses 4 to 6 of the second memory block B2 to the memory device 100 through the memory interface 270. The cell region clear operation for clearing a cell region has been described above and thus detailed description for clearing the second memory block B2 will be omitted.

After the cell region clear operation is performed on the second memory block B2, all memory cells in the cell region corresponding to the physical block addresses 4 to 6 of the cleared second memory block B2 may have the set state or the reset state. The memory cell array 110 in which the second memory block B2 is cleared is illustrated in FIG. 10C. As illustrated in FIG. 10D, after the second memory block B2 is cleared, the status value ‘000’ corresponding to the free area may be stored in the status value fields for the physical block addresses ‘4 to 6’ of the second memory block B2 in the address mapping table AMT.

As described above, since all the memory cells in the free area have the same resistance state, e.g., the set state or the reset state, the memory controller 200 may control the memory device 100 to program only memory cells, which should be programmed to a different resistance state from a current resistance state, in a first write operation for programming the free area. For example, when all the memory cells in the free area have been cleared to the set state, the memory controller 200 may control the memory device 100 to program only memory cells, which should be programmed to the reset state, in the first write operation for programming the free area. In another example, when all the memory cells in the free area have been cleared to the reset state, the memory controller 200 may control the memory device 100 to program only memory cells, which should be programmed to the set state, in the first write operation for programming the free area.

When the write request received from the host is a write request for programming all the memory cells in the free area to the set state in a state that all the memory cells in the free area have been cleared to the set state, the memory controller 200 may not process the write request received from the host and may discard the write request since all the memory cells in the free area already have the set state. Similarly, when the write request received from the host is a write request for programming all the memory cells in the free area to the reset state in a state that all the memory cells in the free area have been cleared to the reset state, the memory controller 200 may not process the write request received from the host and may discard the write request since all the memory cells in the free area already have the reset state.

Accordingly, a memory cell having the reset state can be prevented from being programmed to the reset state again and thus deterioration of memory cell characteristics due to an excessive current flowing to the memory cell may be improved and the power consumption in the write operation may be reduced.

FIG. 11 is a flowchart illustrating an operation method of a memory system according to an embodiment. The operation method will be described with reference to FIGS. 1 to 10D.

In S1110, the cell region management unit 240 of the memory controller 200 may determine whether there is a first cell region to be cleared in the memory device 100 with reference to status value fields for the memory cell array 110 in the address mapping table AMT. A cell region may include a plurality of physical block addresses corresponding to pages of the cell region, and status values corresponding to the plurality of physical block addresses may be stored in the status value fields of the address mapping table AMT. The status values for the physical block addresses may be updated according to statuses of the pages corresponding to the physical block addresses. The status values stored in the state value fields of the address mapping table AMT have been described above and thus detailed description therefor will be omitted.

Referring to FIGS. 7A and 7B, when physical block addresses, which correspond to the status value ‘011’ indicating the allocated area in which invalid data are stored, the status value ‘110’ indicating the spare area in which invalid data are stored, or the status value ‘111’ indicating the non-allocated area, are preset with reference to the status value fields of the address mapping table AMT, the cell region management unit 240 may determine a cell region including the corresponding physical addresses as the first cell region to be cleared.

In S1120, the memory controller 200 may control the memory device 100 to perform the cell region clear operation for allowing all memory cells in the first cell region to be cleared to have a first resistance state or a second resistance state. For example, the first resistance state may refer to the set state and the second resistance state may refer to the reset state. The memory controller 200 may generate the cell clear command CMD_cc for clearing the first cell region and provide the memory device 100 with the generated cell clear command CMD_cc and the address ADDR_cc indicating the first cell region.

The control logic 130 of the memory device 100 may read out data stored in the memory cells in the first cell region based on the cell clear command CMD_cc and the address ADDR_cc received from the memory controller 200, compare each bit of the read-out data with a reference voltage using the comparison unit 131, and determine whether each bit of the read-out data corresponds to the set state or the reset state using the set/reset determination unit 132. Subsequently, the control logic 130 may control the write/read circuit 120 to perform a write operation for programming all the memory cells in the first cell region to the set state or the reset state.

For example, when the cell region clear operation is performed to allow all the memory cells in the first cell region to have the set state, the control logic 130 may control the write/read circuit 120 to perform the write operation for programming only memory cells having the reset state, among the memory cells in the first cell region, to the set state. In another example, when the cell region clear operation is performed to allow all the memory cells in the first cell region to have the reset state, the control logic 130 may control the write/read circuit 120 to perform the write operation for programming only memory cells having the set state, among the memory cells in the first cell region, to the reset state. Accordingly, all the memory cells in the first cell region may be programmed to have the set state or the reset state in the cell region clear operation.

In S1130, when the write request for programming the cleared first cell region, for example, the free area, to the first state or the second state is received from the host, the memory controller 200 may not process the write request and may discard the write request. For example, when the write request received from the host is a write request for programming all the memory cells in the free area to the set state in a state that all the memory cells in the free area have been cleared to the set state, the memory controller 200 may not process the write request received from the host and may discard the write request. Similarly, when the write request received from the host is a write request for programming all the memory cells in the free area to the reset state in a state that all the memory cells in the free area have been cleared to the reset state, the memory controller 200 may not process the write request received from the host and may discard the write request.

Although not shown in drawings, the memory controller 200 may control the memory device 100 to program only memory cells, which should be programmed to a different resistance state from a current resistance state, in a first write operation for programming the first cell region that is now the free area. For example, when all the memory cells in the first cell region have been cleared to the set state, the memory controller 200 may control the memory device 100 to program only memory cells, which should be programmed to the reset state, in the first write operation for programming the first cell region. In another example, when all the memory cells in the first cell region have been cleared to the reset state, the memory controller 200 may control the memory device 100 to program only memory cells, which should be programmed to the set state, in the first write operation for programming the first cell region.

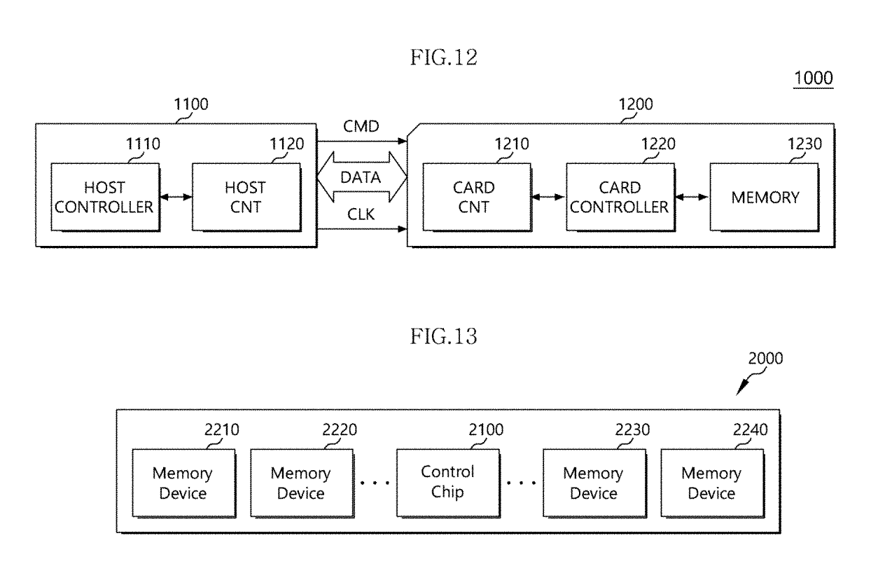

FIG. 12 is a block diagram illustrating a memory card system 1000 according to an embodiment of the present disclosure.

Referring to FIG. 12, the memory card system 1000 may include a host 1100 and a memory card 1200. The host 1100 may include a host controller 1110 and a host connection unit 1120. The memory card 1200 may include a card connection unit 1210, a card controller 1220, and a memory device 1230. The memory card 1200 may be implemented using any of the memory systems according to the embodiments illustrated in FIGS. 1 to 11.

The host 1100 may write data in the memory card 1200 and read out data stored in the memory card 1200. The host controller 1110 may transmit a command CMD, a clock signal CLK generated by a clock generator (not shown) in the host 1100, and data DATA to the memory card 1200 through the host connection unit 1120.

The card controller 1220 may store the data DATA in the memory device 1230 in synchronization with a clock signal generated by a clock generator (not shown) in the card controller 1220 in response to the command CMD received through the card connection unit 1210. The memory device 1230 may store the data DATA transmitted from the host 1100.

The memory card 1200 may be implemented with a Compact Flash card (CFC), a microdrive, a smart media card (SMC), a multimedia card (MMC), a secure digital card (SDC), a memory stick, a USB flash memory driver, or the like.

FIG. 13 is a diagram illustrating a memory module 2000 according to an embodiment of the present disclosure. Referring to FIG. 13, the memory module 2000 may include memory devices 2210 to 2240 and a control chip 2100. Each of the memory devices 2210 to 2240 may be implemented using any of the memory systems according to the embodiments illustrated in FIGS. 1 to 11.

The control chip 2100 may control the memory devices 2210 to 2240 in response to various signals transmitted from an external memory controller. For example, the control chip 2100 may control write and read operations by selectively activating the memory devices 2210 to 2240 based on various commands and addresses transmitted from the external memory controller. The control chip 2100 may perform various post-processing operations on read data DATA output from the memory devices 2210 to 2240. For example, the control chip 2100 may perform an error detection and correction operation on the read data DATA. The control chip 2100 may control the memory devices 2210 to 2240 to control the number of cut-off voltages generated in each of the memory devices 2210 to 2240 or voltage differences between the cut-off voltages.

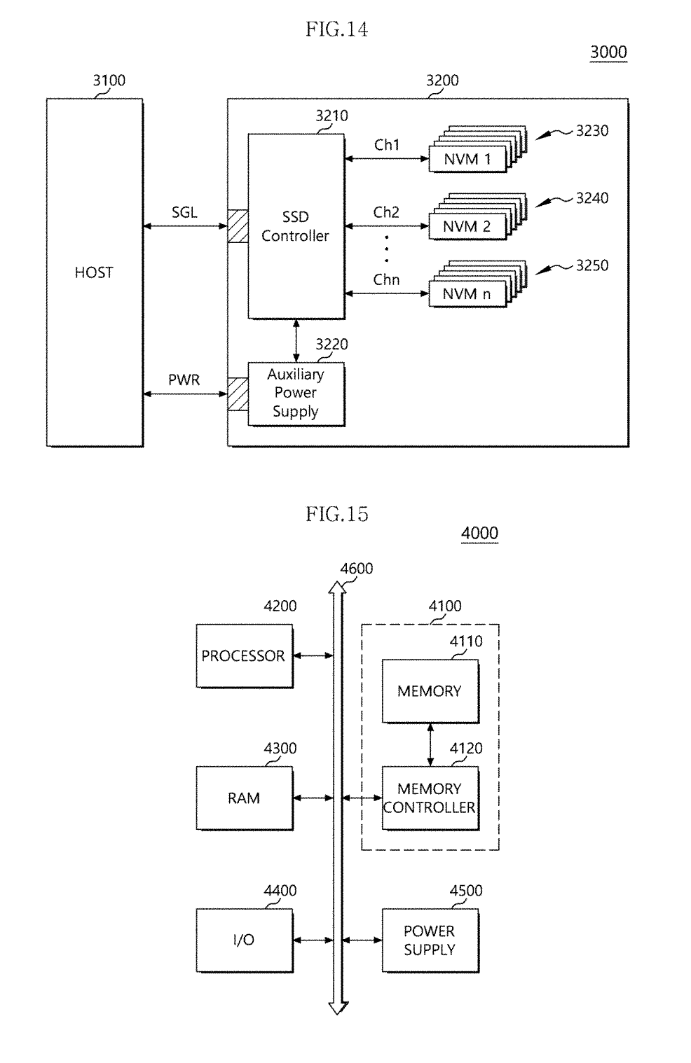

FIG. 14 is a block diagram illustrating an SSD system 3000 according to an embodiment of the present disclosure.

Referring to FIG. 14, the SSD system 3000 may include a host 3100 and an SSD 3200. The SSD 3200 may exchange signals with the host 3100 through a signal connector and receive power through a power connector. The SSD 3200 may include an SSD controller 3210, an auxiliary power supply 3220, and a plurality of memory devices 3230, 3240, and 3250. The SSD 3200 may be implemented using any of the memory systems according to the embodiments illustrated in FIGS. 1 to 11.

FIG. 15 is a block diagram illustrating a computing system 4000 according to an embodiment of the present disclosure.

Referring to FIG. 15, the computing system 4000 may include a memory system 4100, a processor 4200, a RAM 4300, an input/output (I/O) device 4400, and a power supply 4500. Although not shown in FIG. 15, the computing system 4000 may further include ports configured to communicate with a video card, a sound card, a memory card, a USB device, and the like, or ports configured to communicate with other electronic devices. The computing system 4000 may be implemented with a PC or a portable electronic device such as a laptop computer, a portable phone, a personal digital assistant (PDA), or a camera.

The processor 4200 may perform specific calculations or tasks. According to an embodiment, the processor 4200 may be a microprocessor or a central processing unit (CPU). The processor 4200 may communicate with the RAM 4300, the I/O device 4400, and the memory system 4100 through buses 4600 such as an address bus, a control bus, a data bus, and the like. The memory system 4100 may be implemented using any of the memory systems according to the embodiments illustrated in FIGS. 1 to 11.

According to an embodiment, the processor 4200 may be coupled to an expansion bus such a peripheral component interconnection (PCI) bus.

The RAM 4300 may store data required for an operation of the computing system 4000. For example, the RAM 4300 may be implemented with one or more of a DRAM, a mobile DRAM, an SRAM, a PRAM, an FRAM, a ReRAM, an MRAM, and so on.

The I/O device 4400 may include an input unit, such as one or more of a key board, a key pad, a mouse, and so on, and an output unit, such as one or more of a printer, a display, and so on. The power supply 4500 may supply an operation voltage required for an operation of the computing system 4000.

The above described embodiments of the present invention are intended to illustrate and not to limit the present invention. Various alternatives and equivalents are possible. The invention is not limited by the embodiments described herein. Nor is the invention limited to any specific type of semiconductor device. Other additions, subtractions, or modifications are obvious in view of the present disclosure and are intended to fall within the scope of the appended claims.

What is claimed is:

1. A memory system comprising:
a memory device including a plurality of cell regions; and
a memory controller configured to control an operation of the memory device,
wherein the memory controller includes:
a random access memory (RAM) that stores an address mapping table, the address mapping table including physical block addresses for the plurality of cell regions, logical block addresses mapped with the physical block addresses, and status values corresponding to the physical block addresses; and
a cell region management unit configured to determine whether there is a first cell region to be cleared among the plurality of cell regions, based on the status values, generate a cell clear command when there is the first cell region, and transmit the cell clear command to the memory device,
wherein, in response to the cell clear command, the memory device performs a clear operation for programming memory cells in the first cell region to a first resistance state or a second resistance state.

2. The memory system of claim 1, wherein the plurality of cell regions are grouped into a first region that can be recognized by a host and a second region that cannot be recognized by the host.

3. The memory system of claim 2, wherein the status values include:
a first status value indicating that a cell region corresponding to a physical block address is included in the first region and is used by the host and that no data is written in the cell region;
a second status value indicating that the cell region corresponding to the physical block address is included in the first region and is used by the host and that valid data are stored in the cell region;
a third status value indicating that the cell region corresponding to the physical block address is included in the first region and is used by the host and that invalid data are stored in the cell region;
is a fourth status value indicating that the cell region corresponding to the physical block address is included in the first region and is not used by the host;
a fifth status value indicating that the cell region corresponding to the physical block address is included in the second region and that no data is written in the cell region;
a sixth status value indicating that the cell region corresponding to the physical block address is included in the second region and that valid data are stored in the cell region; and
a seventh status value indicating that the cell region corresponding to the physical block address is included in the second region and that invalid data are stored in the cell region.

4. The memory system of claim 3, wherein the cell region management unit determines, as the first cell region, a cell region corresponding to the third status value, the fourth status value, or the seventh status value.

5. The memory system of claim 1, wherein the memory device includes a control logic configured to perform a read operation on the memory cells included in the first cell region in response to the cell clear command, determine whether each of the memory cells has the first resistance state or the second resistance state based on read-out data, and control all the memory cells in the first cell region to be programmed to the first resistance state or the second resistance state.

6. The memory system of claim 1, wherein the first resistance state is a set state and the second resistance state is a reset state.

7. The memory system of claim 6, wherein, when the clear operation is performed to program the memory cells in the first cell region to the set state, the control logic controls memory cells in the first cell region having the reset state to be programmed to the set state.

8. The memory system of claim 7, wherein when a write request for programming the first cell region to the set state is received from a host after the clear operation has been performed on the first cell region, the memory controller discards the write request without processing the write request.

9. The memory system of claim 6, wherein, when the clear operation is performed to program all the memory cells of the first cell region to the reset state, the control logic controls memory cells in the first cell region having the set state to be programmed to the reset state.

10. The memory system of claim 9, wherein when a write request for programming the first cell region to the reset state is received from a host after the clear operation has been performed on the first cell region, the memory controller discards the write request without processing the write request.

11. The memory system of claim 5, wherein the control logic includes:
a comparison unit configured to compare the read-out data with a reference voltage; and
a set/reset determination unit configured to determine whether each of the memory cells in the first cell region has a set state or a reset state according to a comparison result.

12. The memory system of claim 1, wherein the memory controller further includes a wear-level management unit configured to determine a write count for each of the plurality of cell regions and move data stored in a cell region having a write count equal to or larger than a preset write count to another cell region having a write count that is smaller than the preset write count.

13. A method for operating a memory system, the method comprising:
determining whether there is a first cell region to be cleared based on status values in an address mapping table, the first cell region being one of a plurality of cell regions in a memory device, the address mapping table including physical block addresses for the plurality of cell regions, logical block addresses mapped with the physical block addresses, and the status values corresponding to the physical block addresses; and
performing a clear operation on the first cell region, such that memory cells in the first cell region are programmed to a first resistance state or a second resistance state.

14. The method of claim 13, wherein the determining of whether there is the first cell region includes determining whether the address mapping table includes a status value indicating that a cell region stores invalid data or a status value indicating that a cell region is not used by a host, or both.

15. The method of claim 13, wherein the first resistance state is a set state and the second resistance state is a reset state.

16. The method of claim 15, wherein, when the memory cells in the first cell region are programmed to the set state in the clear operation, the performing of the clear operation includes performing a write operation for programming memory cells having the reset state in the first cell region to the set state.

17. The method of claim 16, further comprising:
after performing the clear operation, when a write request for programming the cleared first cell region to the set state is received from the host, discarding the write request without processing the write request.

18. The method of claim 15, wherein, when all the memory cells in the first cell region are programmed to the reset state in the clear operation, the performing of the clear operation includes performing a write operation for programming memory cells having the set state in the first cell region to the reset state.

19. The method of claim 18, further comprising:
after performing the clear operation, when a write request for programming the cleared first cell region to the reset state is received from the host, discarding the write request without processing the write request.
